(19) United States
(12) Patent Application Publication
(10) Pub. No.: US 2014/0199536 A1
(43) Pub. Date: Jul. 17, 2014

(54) MULTILAYER COMPOSITES HAVING IMPROVED PHYSICAL PROPERTIES

(71) Applicants: Johann Kappacher, Piesendorf (AT); Wilhelm Klepsch, Kaprun (AT); Christoph Schett, Zell am See (AT)

(72) Inventors: Johann Kappacher, Piesendorf (AT); Wilhelm Klepsch, Kaprun (AT); Christoph Schett, Zell am See (AT)

(73) Assignee: Senoplast Klepsch & Co., GmbH, Piesendorf (AT)

(21) Appl. No.: 14/118,498

(22) PCT Filed: May 18, 2011
(86) PCT No.: PCT/EP2011/058025

§ 371 Date: Feb. 11, 2014

(51) Int. Cl. B32B 27/08; B32B 37/14

(52) U.S. Cl. CPC B32B 27/08; B32B 37/14
USPC 428/220; 156/244.27

(57) ABSTRACT

The invention relates to a multi-layered composite body, comprising
(i) a cover layer (1) having a layer thickness of 5-50 μm, comprising an acrylic polymer,
(ii) an intermediate layer (2) that is arranged underneath the cover layer (1), comprising a thermoplastic material, which at a layer thickness of 3 mm shows in the entire wave length range of 380 nm to 780 nm a spectral transmission of at least 80%, measured by way of uncoloured test bodies according to ISO 13468-2 (edition 1999) and which has in regard to the acrylic polymer of the cover layer (1) a glass transition temperature that is at least 30° C. higher, defined by the respective “midpoint temperature”, measured by way of DSC method according to ISO 11357-2 (edition 1999-3)
(iii) a substrate layer, comprising a thermoplastic material, which has in regard to the acrylic polymer of the cover layer (1) a glass transition temperature that is at least 30° C. higher, defined by the respective “midpoint temperature”, measured by way of DSC method according to ISO 11357-2 (edition 1999-3), containing pigments, dyes and optionally effect pigments,
(iv) optionally a fourth layer (4), comprising a thermoplastic material, as described in the intermediate layer (2) or in the substrate layer (3), or a blend of acrylonitrile-butadiene-styrene co-polymer (ABS) with a thermoplastic material, as described in the intermediate layer (2) or in the substrate layer (3),
   providing that the overall thickness of the composite body is more than 1.00 mm.

The invention relates to a flat coloured and multi-layered composite body having an overall thickness of more than 1 mm with improved physical characteristics. The invention further relates to methods for the production thereof, the use of such multi-layered composites as moulded bodies and the use of these moulded bodies.

The outdoor use of flat composites presents superior requirements for the materials used, with the most important parameters being:
high dimensional heat stability
high stability against UV and weathering,
high resistance against scratching,
high requirements regarding the mechanical characteristics and
high resistance against chemical elements.

Advantageous are further materials, which are coloured, even using effect pigments, as the provision of components with lacquer is rather complex and expensive.

Multi-layered components for outdoor use are known from the literature. For example, H. Kappacher describes in Kunststoffe 86 (1996), p. 388 to 392, co-extruded PMMA/ABS composite plates. Comparable configurations are also described in the EP 1 761 382 B1. In order to meet the requirements regarding improved dimensional heat stability in an improved way, there are also mentioned configurations having a carrier of an ABS/PC blend (acrylonitrile/butadiene/styrene copolymer-polycarbonate blend) in the previously mentioned article by H. Kappacher. Improvement of the dimensional heat stability is achieved using this material combination.

Co-extruded multi-layered composites are also described in DE 103 51 535 A1. The cover layers defined therein made from particular polymethylmethacrylate co-polymers show good miscibility in the blend with polycarbonate. This is demonstrated by a maximal decrease of tensile stretch by 25% at a proportion of 20% polymethylmethacrylate co-polymers and of 80% polycarbonate. By using this polymethylmethacrylate co-polymer also in the second layer and by optionally adding this polymer to the carrier layer made from polycarbonate, the requirements regarding improved dimensional heat stability shall be achieved.

The EP 0 361 823 B1 describes films, which are based on fluorine containing polymers and which also contain acrylonitrile/butadiene/styrene co-polymers (ABS).

The DE 197 25 560 A1 describes multi-layered bodies having a cover layer made of polymethacrylate (PMMA) and a substrate layer situated underneath, optionally an intermediate layer. The substrate layer is composed of a polymer alloy of a defined composition. The optional intermediate layer is composed of: PMMA, PC or a moulding material, the composition of which being analogous to the polymer alloy defined in the substrate layer. There is described that inventive configurations have improved dimensional heat stability in regard to ABS composites.

### Task and Solution

Prior art does not provide any multi-layered composites, wherein all of the previously mentioned parameters are met to a sufficient extent. The task of the present invention, hence, was the development of a multi-layered composite, which resists long-time temperature impact of 110° C. as a self-supporting, not additionally reinforced, three-dimensional component, without losing its geometrical form and thereby having in addition the following characteristics:
1. one-colour colouring and/or effect colouring in order to avoid lacquering,
2. good resistance against chemical elements and scratching of the surface,
3. high surface quality,
4. good mechanical characteristics of the composite,
5. deep drawing ability (thermal ductility) and
6. excellent UV stability.

This task is solved by a multi-layered, co-extruded composite body having the following layer configuration:
(i) a cover layer (1) having a layer thickness of 5-50 μm, comprising a—preferably thermoplastic—acrylic polymer,
(ii) an intermediate layer (2) that is arranged underneath the cover layer (1), comprising a thermoplastic material, which at a layer thickness of 3 mm shows in the entire wave length range of 380 nm to 780 nm a spectral transmission of at least 80%, preferably at least 85%, measured by way of uncoloured test bodies according to ISO 13468-2 (edition 1999), and which has in regard to the acrylic polymer of the cover layer (1) a glass transition temperature that is at least 30° C. higher, defined by the respective “midpoint temperature”, measured by way of DSC method according to ISO 11357-2 (edition 1999-3),
(iii) a substrate layer (3), comprising at least 85% per weight, preferably at least 90% per weight of a thermoplastic material, which has in regard to the acrylic polymer of the cover layer (1) a glass transition temperature that is at least 30° C. higher, defined by the respective “midpoint temperature”, measured by way of DSC method according to ISO 11357-2 (edition 1999-3), additionally containing pigments, dyes and optionally effect pigments,
(iv) optionally a fourth layer (4), comprising a material, as described in the intermediate layer (2) or in the substrate layer (3), or a blend of acrylonitrile-butadiene-styrene co-polymer (ABS) with a material, as described in the intermediate layer (2) or in the substrate layer (3),
   providing that the overall thickness of the composite body is more than 1.00 mm.

The inventors have found out that such multi-layered, co-extruded composite bodies combine thermal, optical as well as mechanical, physical and chemico-physical characteristics, which meet the criteria mentioned above and which resist long-time temperature impact of 110° C.

Preferred embodiments are described below.

### Cover Layer (1)

The cover layer (1) comprises an acrylic polymer, in the preferred case PMMA, impact modified PMMA (HI-PMMA) or a blend thereof. Optionally, the cover layer (1) may have UV absorbers and UV stabilizers in order to achieve higher UV stability of the surface and the composite. Preferably, the cover layer (1) has at least 95% per weight of an acrylic polymer, preferably PMMA, HI-PMMA or a blend thereof. In particular the cover layer (1) has no other components apart from the acrylic polymer and optionally UV absorbers and UV stabilizers. The most important characteristics of PMMA are summarized in Hans Domininghaus, “Die Kunststoffe and ihre Eigenschaften”, edition 1998, page 455-481. Due to the characteristics described, PMMA is particularly suitable as a cover layer material for outdoor use, as it is already very UV stable and scratch resistant by its own, as it shows very good stability against chemical components and as it is transparent. It has, however, in comparison with other thermoplasts the disadvantage that it shows brittle mechanical behaviour. Another disadvantage is its rather low dimensional heat stability: already at relatively low temperatures, PMMA will become plastic. For this reason, it is used in the inventive configuration only in a very thin layer. By using UV protectives (UV absorbers and UV stabilizers) to the extent of 0.01 to 5% by weight, the materials and dyes used in the intermediate layer (2) are additionally protected against UV radiation, which is why mechanical behaviour as well as colour stability will be significantly improved during use upon irradiation with UV light. In order for the intermediate layer (2) to remain clearly visible underneath the cover layer (1), the acrylic polymer of the cover layer (1) (preferably PMMA, HI-PMMA or the blend thereof) has a spectral transmission in the entire visible wave length range of 380 nm to 780 nm of at least 80%, preferably at least 85%, especially preferably at least 90%, measured by way of test bodies according to ISO 13468-2 having a layer thickness of 3 mm. The spectrum of light visible for the human eye lies within the band of 380 nm to 780 nm. There is preferably provided that the cover layer (1) is composed exclusively of PMMA, HI-PMMA and optionally UV absorbers and/or UV stabilizers.

### Intermediate Layer (2)

The intermediate layer (2) comprises materials, which meet the requirements described below. As a thermoplastic material there is understood in the frame of the invention a plastic material, which may be thermally formed within in a particular temperature range. Thermoplastic formability is a reversible process so that the thermoplastic material may be repeated any number of times by cooling and heating into the formable state. As thermoplastic materials, there are summarized pure plastic materials (homopolymers, heteropolymers and/or co-polymers) and plastic blends (mixtures of various plastic materials).

### Transmission:

In the visible light spectrum (380 nm to 780 nm) the spectral transmission of the thermoplastic material amounts to at least 80% (preferably at least 85%), measured by way of colourless test bodies according to ISO 13468-2 (edition: 1999) having a layer thickness of 3 mm. Naturally, the thermoplastic material may also be a blend of plastic materials. In the case that the thermoplastic material is a plastic material blend, this plastic material blend should show a spectral transmission of at least 80%, measured by way of test bodies according to ISO 13468-2 (edition: 1999) having a layer thickness of 3 mm in the entire wave length range of 380 nm to 780 nm.

This high transparency is required in order to enable the effect colouring in particular in the substrate layer (3)—that is required for the use of the components made from this semi-finished product. The optical effect of these effect pigments is based on the orientation of the lamellae in parallel to the surface of the surrounding system, which is why upon incidence of light there will be developed a directed reflexion at the surface thereof, with directed light dispersion occurring at the edges of the effect pigments. If opaque materials were used, additional material-conditioned effects of dispersion and absorption would occur, which is why the effect will significantly decrease in brightness or will disappear at all, respectively.

### Glass Transition or Softening Temperature (T_{G}):

The glass transition or softening temperature T_{G} is the temperature, at which a plastic material has the largest change of deformability. This so-called glass transition will divide the brittle and energy-elastic range (=glass range) situated underneath from the soft entropy-elastic range (=rubber-elastic range) situated above. The softening temperature is measured using a DSC measuring device according to ISO 11357-2:1999, and it is characterized by the “midpoint temperature”. In order to meet the requirements of heat resistance, the thermoplastic material is required to have a glass transition temperature that is at least 30° C. higher in regard to the acrylic polymer—preferably PMMA, HI-PMMA or a blend thereof—of the cover layer (1), measured by way of DSC method according to ISO 11357-2 (edition 1999-3). Research of the inventors has shown that only composite bodies that are made from such materials in the intermediate layer (2) do meet the requirement regarding hour-long storage at 110° C. without geometrical deformation. It is obvious that the thermoplastic material may also be a blend of plastic materials, or it may be required, respectively, to add materials in order to achieve the desired characteristics. In the case that the thermoplastic material is a plastic material blend, at least 85% per weight, preferably at least 90% per weight of the intermediate layer (the thermoplastic material) shall have a glass transition temperature that is at least 30° C. higher in regard to the acrylic polymer of the cover layer (1), defined by the respective “midpoint temperature” of at least 30° C., measured by way of DSC method according to ISO 11357-2 (edition 1999-3).

There may be optionally added in addition UV absorbers, UV stabilizers as well as pigments, dyes and/or effect pigments to the intermediate layer (2). In a preferred embodiment variant of the invention there may be made the provision that the intermediate layer (2) comprises, apart from the optional UV absorbers, UV stabilizers as well as pigments, dyes and/or effect pigments, only the thermoplastic material, which shows, having a layer thickness of 3 mm, in the entire wave length range of 380 nm to 780 nm a spectral transmission of at least 80%, measured at test bodies according to ISO 13468-2 (edition 1999) and which has in regard to the acrylic polymer of the cover layer (1) a differential temperature in the glass transition point, defined by the respective “midpoint temperature”, of more than 30° C., measured by way of DSC method according to ISO 11357-2 (edition 1999-3).

### Substrate Layer (3)

The substrate layer represents the highest proportion of the overall layer thickness of the composite in per cent and comprises a thermoplastic material, which has in regard to the acrylic polymer of the cover layer (1) a glass transition temperature that is at least 30° C. higher, defined by the respective “midpoint temperature” of at 30° C., measured by way of DSC method according to ISO 11357-2 (edition 1999-3). This substrate layer (3) further contains pigments, dyes and optionally effect pigments.

Naturally, there may also be present a blend of plastic materials as thermoplastic material or it may be required, respectively, to add additional elements in order to achieve the desired characteristics. In the case that the thermoplastic material is a plastic material blend it is also necessary that at least 85% per weight (especially preferably at least 90% per weight) of the substrate layer (3) have a glass transition temperature that is at least 30° C. higher than the acrylic polymer of the cover layer (1), defined by the respective “midpoint temperature”, measured by way of DSC method according to ISO 11357-2 (edition 1999-3).

Especially preferably there is provided that the thermoplastic material of the substrate layer (3) is essentially identical with the thermoplastic material of the intermediate layer (2). In the multi-layered composite according to the invention the substrate layer (3) may contain the pure thermoplastic material having the characteristics at T_{G}—as described above. Optionally, in addition or alternatively thereto, the substrate layer (3) may contain a recyclate or regenerate of the intermediate layer (2) or of the substrate layer (3) (e.g., of preceding production steps) or blends thereof. The characteristics are not affected by the use of regenerates, waste materials, recyclates, etc. In a preferred embodiment variant of the invention there is provided that the substrate layer (3) comprises, apart from the pigments, dyes and/or effect pigments, merely the thermoplastic material, which, having a layer thickness of 3 mm, shows in the entire wave length rage of 380 nm to 780 nm a spectral transmission of at least 80%, measured by way of test bodies according to ISO 13468-2 (edition 1999), and which has in regard to the acrylic polymer of the cover layer (1) a differential temperature in the glass transition point, defined by the respective “midpoint temperature”, of more than 30° C., measured by way of DSC method according to ISO 11357-2 (edition 1999-3).

### Optional Fourth Layer (4)

There may optionally also be provided a fourth layer (4). This preferably comprises a thermoplastic material having the characteristics as described in the intermediate layer (2) or in the substrate layer (2) or a blend of acrylonitrile-butadiene-styrene co-polymer (ABS) with a thermoplastic material like in the intermediate layer (2) or the substrate layer (3). It is especially preferred that there are not contained any further thermoplastic materials in the fourth layer (4).

If the fourth layer (4) is composed essentially of the thermoplastic material as described in the intermediate layer (2) or the substrate layer (3), then there may be added matting agents to the layer (4). As matting agents are in general designated additives, which have such an effect to the surface of a covering so that the grade of gloss thereof will be decreased. This mostly entrails increase of the surface roughness, which in the subsequent process, this is thermal forming, leads to an improved flow of the thermoplastic mass over the die. In this way, there is achieved a uniform residual wall distribution on the three-dimensional components.

Suitable matting agents are known to those skilled in the field and comprise, for example, inorganic fillers, in particular silicic acid or cross-linked polymers in pearl-like form (“polymer pearls”), preferably acrylate pearls. The amount added preferably lies between 0.1% per weight and 5% per weight.

If the fourth layer (4) is composed of blends of ABS with the material, as it is used in the intermediate layer (2) or in the substrate layer (3), then there may also be created, due to the morphology given in the blend, a matted back-side cover layer, which has the same positive effect on the further processing as the addition of a matting agent. Normally, an additional matting agent may be omitted with this configuration. Due to the low glass transition temperature of ABS the fourth layer (4) should be very thin. It has been shown that a layer thickness of the fourth layer of 5-50 has no negative influence on the geometry of the components of the configuration according to the invention upon impact of a temperature of 110° C. for several hours.

### Effect Pigments

Effect pigments as used in the layer (2) may be divided into two comprehensive classes, the pearl gloss pigments and the metal effect pigments, according to literature, Gunter Buxbaum, “Industrial Inorganic Pigments”, edition 1993, page 207-224. Pigments of this kind may be used in order to achieve special visual effects; they may, however, also be used in combination with normal pigments and/or dyes.

### Production of the Semi-Finished Products

The multi-layered composite bodies according to the invention may be produced in a single-step procedure by way of adapter or nozzle co-extrusion. In this way, materials of the layers (1), (2), (3) and optionally (4) are made flowable in respectively one extruder through thermal impact and are then combined in an adapter system or a multi-channel nozzle into said multi-layered composite.

Another way of production offers lamination. Thereby, films are laminated against each other corresponding to the layers (1), (2), (3) and optionally (4) of the configuration according to the invention in a heated roller gap. The defined layer configuration is combined thereby by positioning films in the defined layer order and by subsequent pressing using temperature and pressure. The films to be used for this end have to be produced before, e.g., by way of extrusion, in the respective layer thickness.

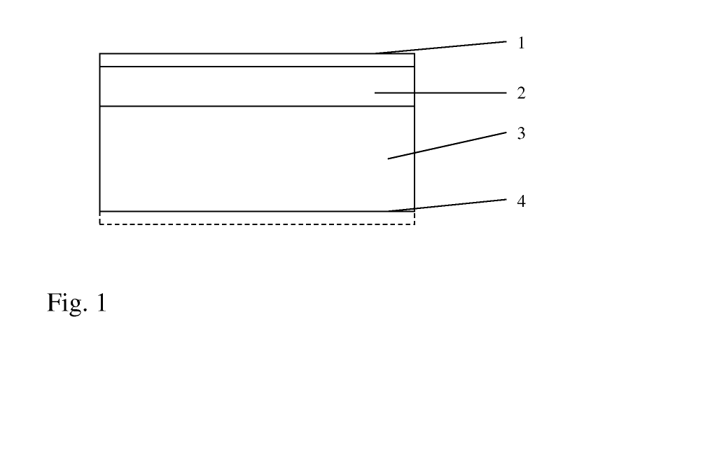

The multi-layered composites such produced are also designated as semi-finished products. The preferred method of production is co-extrusion. Multi-layered composite bodies according to the invention are explained in FIG. 1, wherein the cover layer (1), the intermediate layer (2), the substrate layer (3) and the optional fourth layer (4) are illustrated. As the fourth layer (4) is only optionally provided, it is illustrated in dotted lines.

### Processing of the Semi-Finished Products

Components made of multi-layered composites as defined above and also in the attached claims may be produced from the two-dimensional semi-finished products by way of thermal forming (thermoforming). Thereby, the multi-layered composites are heated in a deep-drawing device above softening point and immediately afterwards drawn over a tempered die. By applying vacuum in the air space, which is situated between the thermoplastic semi-finished product and the tempered die, the semi-finished product is pressed towards the die; it is cooled and subsequently demoulded. In the following the mould blank is then trimmed to the correct dimension, which gives a three-dimensional component having a defined, very well reproducible geometry.

### Requirements for the Components

Temperatures in a range, which causes failure with prior art components, and significantly beyond thereof, e.g., occur on horizontal, two-dimensional components, which are dark coloured (e.g., vehicle bodies). Tests have thus shown, wherein said components were exposed to Central European weather conditions with continuous recording of surface temperature, that there are reached temperature peaks of more than 90° C. on hot summer days. The failure of thermoformed parts is expressed in all cases by a change of the original geometrical form, making these unsuitable for use. From actual practice there is further known that components on the basis of a PMMA-ABS co-extrudate lose their geometrical form in the case of permanent use beyond 80° C., on the basis of a PMMA-ABS/PC blend at about 90° C. On configurations, as described in the DE 197 25 560 A1 (PMMA-PMMA-ASA/PC and PMMA-PC-ASA/PC), deformation occurs between 85 and 90° C., PMMA-PMMA-PC or PMMA-PMMA-PC/PMMA, respectively, according to the DE 103 51 535 A1 (RÖHM) will fail at 100° C. As components made from said configurations, however, are also used in Mediterranean climatic zones having significantly higher temperatures than in Central Europe, the requirements in this regard are also significantly increased: There is a demand for components made from materials having dimensional heat stability above 110° C. for several hours.

The mechanism of failure is thereby based on the fact that with increasing temperature the component will lose rigidity, will become plastic and will be deformed due to its inherent weight.

In order to simulate the temperature impact on components having different multi-layered configurations and to evaluate the effects of temperature onto the geometrical form there has been developed a proper test method. This is based on components being represented by way of a deep-drawing mould, wherein the geometry is similar to a vehicle roof. This component is then geometrically measured and stored at defined temperatures in a heating cabinet for two hours. Subsequently, the part is removed, then air-conditioned at room temperature for another hour, and then the geometry is determined anew. If there is detected a change of geometry, there may be assumed that the component does not meet the requirement of temperature in regard to heat storage.

One possibility to increase the heat stability of components is to reinforce those using fibre-reinforced duroplasts at their back-side. Though the additional application of fibre-reinforced duroplasts as reinforcement leads to an improvement in regard to heat stability, this, however, will also lead to significantly increased costs, as there are required, on the one side, additional process steps, and, on the other side, also additional material quantities for the application of the reinforcement layer.

Due to commercial reasons, the invention thus is not based on duroplast-reinforced components but rather on multi-layered composites, as these are described in the EP 1 761 382 B1 (Sabic), DE 103 51 535 A1 (RÖHM), and DE 197 25 560 A1 (BASF). Hence, there were illustrated from configurations as described in these publications test components and examined by way of heat storage test at 110° C. The results are summarized in table 1.

TABLE 1
Results of the heat storage at 110° C./2 h with components
of different multi-layered configurations (V1-V5 are comparative
examples, layer 3 of V5 is composed of 60% by weight PC
(polycarbonate) and 40% by weight ASA; A6 is an example
according to the invention).

| | Layer configuration | | | Geometry following heat |
|---|---|---|---|---|
| | (1) | (2) | (3) | storage at 110° C./2 h |
| V1 | PMMA | PMMA | ABS | Complete loss of geometrical form |
| V2 | PMMA | PMMA | ABS/PC | Complete loss of geometrical form |
| V3 | PMMA | PMMA | ASA/PC | Complete loss of geometrical form |
| V4 | PMMA | PMMA | PC | Not acceptable warping detectable |
| V5 | PMMA | PC | ASA/PC | Complete loss of geometrical form |
| A6 | PMMA | PC | PC | No change of geometrical form |

In order to determine the impact factors regarding the failure of the components, the thermal parameters were summarized in table 2:

TABLE 2
Thermal parameters of the materials from different configurations (V1-V5
are comparative examples, A6 is an example according to the invention).

| | Layer | | | E- modulus | | | | | | |
|---|---|---|---|---|---|---|---|---|---|---|
| | configuration | | | 100° C. [MPa] | | | T_{G} [° C.] | | | E- |
| | (1) | (2) | (3) | (1) | (2) | (3) | (1) | (2) | (3) | modulus* |
| V1 | PMMA | PMMA | ABS | 780 | 780 | 850 | 109 | 109 | 110 | 830 |
| V2 | PMMA | PMMA | ABS/PC | 780 | 780 | 1340 | 109 | 109 | 111/147 | 1100 |
| V3 | PMMA | PMMA | ASA/PC | 780 | 950 | 1160 | 114 | 109 | 115/145 | 1000 |
| V4 | PMMA | PMMA | PC | 960 | 960 | 1900 | 107 | 107 | 148 | 1850 |
| V5 | PMMA | PC | ASA/PC | 780 | 1900 | 1160 | 114 | 148 | 115/145 | 1150 |
| A6 | PMMA | PC | PC | 780 | 1900 | 1900 | 114 | 148 | 153 | 1900 |

*E-modulus of the entire composite at 100° C.

Determination of the E-modulus at 100° C. was performed according to ISO 527-2, wherein the tensile test was carried out in a heatable cabinet. The determination of the glass transition temperature or softening temperature (T_{G}) was measured by way of a DSC measuring device (Differential Scanning calorimetry) according to ISO 11357-2:1999, and it is characterized by the “midpoint temperature”. This is the temperature at which a plastic material will have the largest change of deformability. This so-called glass transition divides the brittle energy-elastic range (=glass range) situated underneath from the soft entropy-elastic range (=rubber-elastic range) situated above.

As there was surprisingly concluded from the results of the tables 1 and 2, it is necessary, in order to achieve the requirements of a geometric dimensional stability upon impact of temperatures of 110° C. for several hours, to keep the cover layer made from PMMA in a thickness range between 5 and 50 μm and to select the material used for the layers (2) and (3) underneath in such a way that there may be determined a differential temperature in the glass transition point of at least 30° C., measured by way of DSC method according to ISO 11357-2 (edition 1999-3). In order to enable the effect colouring required in the use of the components made from the semi-finished products, there is further required a transmission in the visible light spectrum of at least 85%, measured by way of colourless test bodies according to ISO 13468-2, having a layer thickness of 3 mm. In the comparative example V5 there may be seen that an ASA/PC blend with 60% per weight PC, wherein the PC has a glass transition point that is 30° C. higher than the PMMA of the cover layer had, does not meet the requirements. Only with at least 85% by weight of thermoplasts in the substrate layer with a T_{G} that is 30° C. higher is it possible to achieve the desired results.

What is claimed is:

1. A multi-layered composite body, comprising in this order
(i) a cover layer having a layer thickness of 5-50 μm, comprising an acrylic polymer,
(ii) an intermediate layer that is arranged underneath the cover layer, comprising a thermoplastic material, which at a layer thickness of 3 mm shows in the entire wave length range of 380 nm to 780 nm a spectral transmission of at least 80%, measured by way of test bodies according to ISO 13468-2 (edition 1999) and which has in regard to the acrylic polymer of the cover layer a glass transition temperature that is at least 30° C. higher, defined by the respective “midpoint temperature”, measured by way of DSC method according to ISO 11357-2 (edition 1999-3),
(iii) a substrate layer, comprising at least 85% per weight of a thermoplastic material, which has in regard to the acrylic polymer of the cover layer a glass transition temperature that is at least 30° C. higher, defined by the respective “midpoint temperature”, measured by way of DSC method according to ISO 11357-2 (edition 1999-3), containing pigments, dyes and optionally effect pigments,
(iv) optionally a fourth layer, comprising a thermoplastic material, as described in the intermediate layer or in the substrate layer, or a blend of acrylonitrile-butadiene-styrene co-polymer (ABS) with a thermoplastic material, as described in the intermediate layer or in the substrate layer,
with the provision providing that the overall thickness of the composite body is more than 1.00 mm.

2. A composite body according to claim 1, wherein the thermoplastic material of the substrate layer is essentially identical with the thermoplastic material of the intermediate layer.

3. A composite body according to claim 1 wherein the intermediate layer contains pigments, dyes, effect pigments or a combination thereof.

4. A composite body according to claim 1 wherein the intermediate layer contains UV absorbers, UV stabilizers or a combination thereof.

5. A composite body according to claim 1 wherein the intermediate layer contains at least 85% per weight, of a thermoplastic material, which at a layer thickness of 3 mm has in the entire wave length range of 380 nm to 780 nm a spectral transmission of at least 80%, measured by way of test bodies according to ISO 13468-2 (edition 1999) and which has in regard to the acrylic polymer of the cover layer a differential temperature in the glass transition point, defined by the respective “midpoint temperature”, of more than 30° C., measured by way of DSC method according to ISO 11357-2 (edition 1999-3).

6. A composite body according to claim 1 wherein the cover layer comprises PMMA, impact-modified PMMA (HI-PMMA) or a blend thereof.

7. A composite body according to claim 1 wherein the cover layer has UV absorbers, UV stabilizers or a combination thereof.

8. A composite body according to claim 6 wherein the cover layer consists exclusively of PMMA, HI-PMMA and optionally UV absorbers, UV stabilizers or a combination thereof.

9. A composite body according to claim 1 wherein the acrylic polymer of the cover layer as a test body at a layer thickness of 3 mm has in the entire wave length range of 380 nm to 780 nm a spectral transmission of at least 80%, according to ISO 13468-2.

10. A composite body according to claim 1 wherein the substrate layer contains at least 90% per weight of a thermoplastic material, which has in regard to the acrylic polymer of the cover layer a glass transition temperature that is at least 30° C. higher, defined by the respective “midpoint temperature”, measured by way of DSC method according to ISO 11357-2 (edition 1999-3).

11. A composite body according to claim 1 which is mouldable in three dimensions.

12. A three-dimensionally moulded body, comprising a composite body according to claim 1.

13. A method for the production of a multi-layered composite body according to claim 1 which the materials of the cover layer, the intermediate layer, the substrate layer and optionally the layer are made flowable in respectively one extruder by thermal impact and combined in an adapter system or in a multi-channel nozzle, wherein any additional substances of the respective layer are introduced into the respective extruder during the thermal impact.

14. A method for the production of a multi-layered composite body according to claim 1 wherein the materials of the cover layer, the intermediate layer, the substrate layer and optionally the layer are laminated against each other, preferably in a roller gap under the impact of temperature and pressure.

15. The use of a multi-layered composite body according to according to claim claim 1 as vehicle body, as a furniture element, as a transport trolley case, as a transport container or the like.
